(19) United States
(12) Patent Application Publication
(10) Pub. No.: US 2013/0159528 A1
(43) Pub. Date: Jun. 20, 2013

(54) FAILOVER BASED APPLICATION RESOURCE ACQUISITION

(71) Applicants: Eric Jewart, Waltham, MA (US); Jeremy Dunker, Boston, MA (US)

(72) Inventors: Eric Jewart, Waltham, MA (US); Jeremy Dunker, Boston, MA (US)

(73) Assignee: MICROSOFT CORPORATION, Redmond, WA (US)

(21) Appl. No.: 13/327,466

(22) Filed: Dec. 15, 2011

(51) Int. Cl. G06F 15/173

(52) U.S. Cl. 709/226

(57) ABSTRACT

Providing access to resources to an application. A method includes receiving a request from an application for one or more resources. The method further includes determining that the one or more resources are not available at a primary or local storage. The method further includes identifying one or more alternative locations where the one or more resources are available. Transparently to the application, the one or more resources are provided from one or more of the one or more alternative locations

### BACKGROUND

### Background and Relevant Art

Computers and computing systems have affected nearly every aspect of modern living. Computers are generally involved in work, recreation, healthcare, transportation, entertainment, household management, etc.

Computer applications are often made up of various discrete components that work in concert to accomplish computing tasks. Such discrete components may include things such as data files, module files, configuration settings, etc. These discrete components may be referred to as computing resources. Computing resources can become lost, unusable, out of date, etc. For example, a computing resource file may be unintentionally deleted by user action. Alternatively, a computing resource may become corrupted by user action, faulty hardware, interfering communications, or by other means. Alternatively, a computing resource may become out of date due to various data synchronization failures.

If at any time, an application attempts to access one of these resources and it is either: not present, inaccessible, out of date, etc. the application may fail to function properly. Requests to resources that are missing, corrupted, out of date, etc. will generally cause an error and prevent a computer program from continuing to run at all or in a way that allows the computer program to fully perform the functions for which it was created.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment is directed to a method that may be practiced in a computing environment. The method includes acts for providing access to resources to an application. The method includes receiving a request from an application for one or more resources. The method further includes determining that the resources are not available at a primary or local storage. The method further includes identifying one or more alternative locations where the resources are available. Transparently to the application, the one or more resources are provided from one or more of the one or more alternative locations.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1A illustrates application resource requests against various data stores;

FIG. 1B illustrates an example of migrating an application from one machine to another machine; and

FIG. 2 illustrates a method of providing access to resources to an application.

### DETAILED DESCRIPTION

Some embodiments described herein identify application resource requests which fail during application execution and use alternative data sources to fulfill the requests. This technique can be leveraged in several different scenarios including the creation of application packages, application migration and application self-repair. Some embodiments may be used to create virtual application packages for an application that is installed on a different machine.

As noted previously, applications run on a system and access various resources, such as files, configuration setting, etc., throughout their execution. If at any time, the application attempts to access one of these resources and it is either not present or inaccessible, the application may fail to function properly. Some embodiments herein leverage one or more alternative sources of application resources which allow the application to automatically recover from a failed attempt to access a resource. Thus, some embodiments implement automated use of one or more secondary data stores to fulfill failing resource requests. Alternatively, embodiments may use one or more secondary data stores to migrate an application from one location to another.

Embodiments may include functionality to take a resource request from an application that is traditionally destined for a single location and attempt to fulfill it from one or more additional data stores. Fulfilling this request can be done by redirecting the request to an alternate location. Alternatively or additionally, fulfilling this request can be done by retrieving and incorporating the data from the secondary store into the primary store when it is not already available in the primary store.

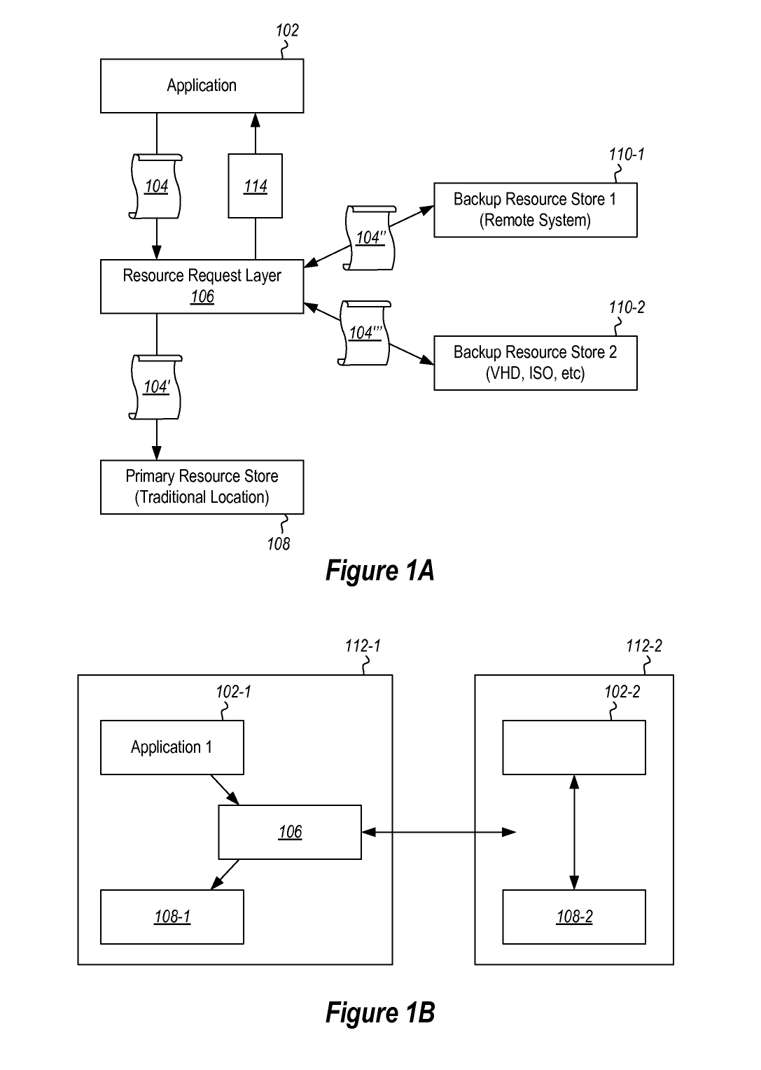

Referring now to FIG. 1A, an illustrative example is illustrated. FIG. 1A illustrates an example embodiment implementing layered requests. In particular, FIG. 1A illustrates an application 102. The application 102 sends a request 104 that is intercepted by a resource request layer 106. In some embodiments, a DLL may be injected into a process of interest to act as the intermediary resource request layer 106. In some specific embodiments, the DLL may use API hooking to provide the intermediary functionality.

Some embodiments divide resource stores into two groups. There is a single resource store designated as the primary store 108 and one or more secondary stores (illustrated as 110-1 and 110-2 in FIG. 1A). When the application 102 requests a resource, the request 104 is routed through an intermediary (i.e. the resource request layer 106) that first attempts to fulfill the request 104 by sending a request 104′ to the primary resource store 108. If this fails, the intermediary transforms the original request to a request 104″ against a secondary store, such as store 110-1, and issues a new resource request 104″. This action is repeated for each secondary data store (such as is illustrated by request 104′″ and data store 110-2) until the request can be fulfilled or there are no more data stores.

Embodiments may be implemented where the primary data store 108 is a system dedicated to creating virtual application packages. In some such embodiments, a second running system may be treated as the secondary data store. Thus, one running system may be a backup for another system or two or more functioning implementations of an application may be used as backup resources for each other.

Other alternative data stores may be used. For example, some embodiments may implement a backup data store (referred to generally as 110 though shown specifically at 110-1 and 110-2) using a virtual hard disk, a DVD, installer packages, or other data structures.

Some embodiments may use simple access failure detection at the resource request layer 106 to determine whether or not a resource is available at a data store 108 or backup data store 110. Alternatively or additionally, alternative heuristics can be applied to an access check. One example of an alternative heuristics is using resource modification times to determine if the primary data store resource is the most up-to-date version.

Some embodiments may use the functionality described herein to implement self-repair functionality. An application 102 can effectively repair itself if the data in the primary store 108 is inaccessible by using the layered approach with a copy-on-access policy for the secondary store 110. For example, when the intermediary 106 is able to fulfill the resource request in a secondary store 110, the content is copied from the secondary store 110 to the primary data store 108 and the request 104′ is re-issued against the primary store 108.

If two systems are running the same software, each of these can be configured to treat the other as a secondary store. In the event that one of the systems experiences a failure resulting in lost application resources, that system can attempt to repair itself using the other machine's resources.

Some embodiments may be configured to implement migration functionality. Migrating an application from one machine to another can be done in a fashion similar to the self-repair functionality but on a larger scale. By using a small portion of the application as an entry point, the full installation can be migrated from one system to another over time.

FIG. 1B illustrates an example of such functionality. In particular, FIG. 1B illustrates where an application is migrated to a first machine 112-1 from a second machine 112-2. To begin the migration an application component 102-1 can be installed on the first machine. Another instance of the application component 102-2 may be running on the second machine from which the application is to be migrated. Further, in the illustrated example, the first machine 112-1 has the resource request layer 106 installed on it. The first application component can then be allowed to run. When the first application component 102-1 attempts to access application resources that are not available in the local store 108-1, the resource request layer 106 will obtain those resources from the local store 108-2 from the second machine 112-2. The application component 102-1 can be run in this fashion until the application has been fully migrated from the second machine 112-2 to the first machine 112-1.

Determining that an application has been migrated can be accomplished in a number of different ways. For example, in one embodiment, it can be determined that the resource request layer 106 has not requested any resources from the local store 108-2 for a statistically long period of time. In another alternative example, a user could perform a set of tests on the migrated application and verify that it functions correctly.

Some embodiments may be implemented to create an application package. For example, some embodiments can implement functionality to build a virtual application package for an application that has already been installed on a machine. By combining the failover technique described here and other existing monitoring processes, such as those used by App-V Sequencer available from Microsoft® Corporation of Redmond Washington, embodiments can effectively “install” an application on a station without having the installation media.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

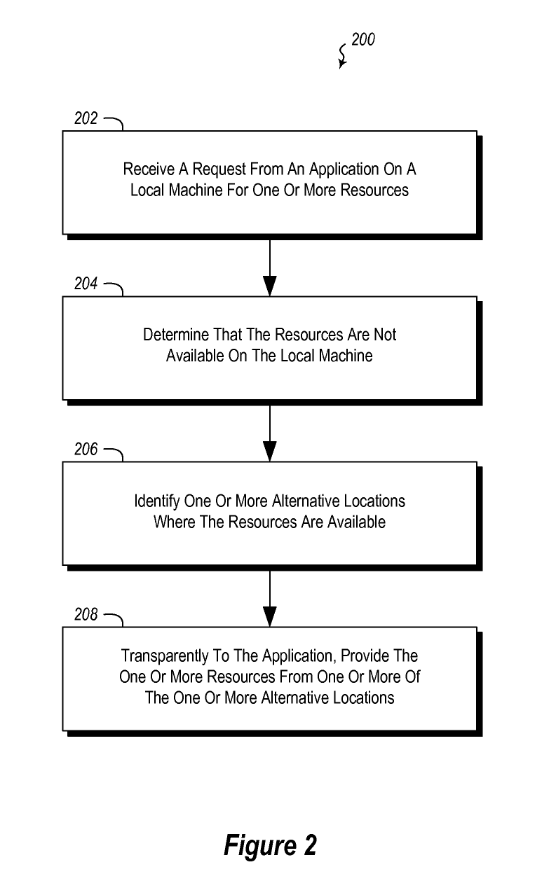

Referring now to FIG. 2, a method 200 is illustrated. The method 200 may be practiced in a computing environment. The method 200 includes acts for providing access to resources to an application. The method 200 includes receiving a request from an application on a local machine for one or more resources (act 202). For example, as illustrated in FIG. 1A, the application 102 may send a request 104 for resources.

The method 200 further includes determining that the one or more resources are not available on the local machine (act 204). For example, a determination may be made that the resources are not available in the primary resource store 108. Such a determination may be made based on, for example, the resources being not present, not up to date, not valid, corrupted, etc.

The method 200 further includes identifying one or more alternative locations where the one or more resources are available (act 206). For example, as illustrated in FIG. 1A, the backup resources 110-1 and 110-2 may be identified as locations where resources are available. The alternative locations may be, for example, a second fully operating system, a virtual hard disk image, an MSI file, etc.

The method 200 further includes transparently to the application, providing the one or more resources from one or more of the one or more alternative locations (act 208). For example, as illustrated in FIG. 1A, the resource request layer 106 can provide resources from the backup resource stores 110-1 and 110-2 transparently to the application 102. In particular, the application 102 may not be aware of where the resources come from. The application may assume that the resources are being delivered from the primary resource store 108.

The method 200 may be practiced where providing the one or more resources from the one or more alternative locations includes migrating the one or more resources to the local machine. For example, FIG. 1B illustrates an example where resources are migrated from a second machine 112-2 to a first machine 102-1. As resources are needed and/or requested, they can be migrated from the second machine 112-2 to the first machine.

The method 200 may be practiced where providing the one or more resources from the one or more alternative locations includes repairing an installation of the application at the local machine using the one or more resources from the alternative location. For example, when it is detected that resources are missing, corrupted, out of date, etc., not only can a request for the resource be satisfied using alternative locations, but additionally, the resources that are retrieved from alternative locations can be stored at a local machine and/or added to an installation such that subsequent requests for the resources does not require that the resources be retrieved from the alternative locations.

In some embodiments, an installation may be repaired by deleting a resource. For example, using the modalities described herein it may be determined that some resource has been deleted from an alternative location and that the same resource needs to be deleted from the primary store, thus preventing the application from accessing it. For example, an application might function “correctly” only in the absence of some resource, like a configuration setting or file.

The method 200 may be practiced where providing the one or more resources from the one or more alternative locations includes building a redistributable package that contains resources to redistribute the application to another destination. For example, a package may be created that includes all resources needed to install a working example of an application at a different location.

The method 200 may further include querying one or more of the one or more alternative locations on behalf of the application. For example, as illustrated in FIG. 1A, the resource request layer can send requests 104″ and 104′″ to the stores 110-1 and 110-2 on behalf of the application 102.

The method 200 may be practiced where identifying one or more alternative locations where the resources are available includes identifying a more optimal alternative location and obtaining the resources from the optimal alternative location. For example, embodiments may identify a location that is more preferred than other locations due to the physical location of the alternative location, connectivity to the alternative location, hardware capacity of the alternative location, accessibility to the alternative location, trusted nature of the alternative location, etc.

The method 200 may be practiced where, providing the one or more resources from the one or more alternative locations includes composing resources from multiple alternative locations to satisfy a single request from the application. For example, as illustrated in FIG. 1A, the request 104 may require resources that cannot be obtained from the primary resource store 108. However, it may be the case that resource store 110-1 cannot alone satisfy the request 104 with resources stored there and that resource store 110-2 cannot alone satisfy the request 104 with resources stored there. However, the resource store 110-1 may be able to provide some of the resources to satisfy the request 104 and the resource store 110-2 may be able to provide any remaining resources not provided by the resource store 110-1.

The method 200 may be practiced where receiving a request from an application on a local machine for one or more resources includes intercepting a request from the application's ordinary request mechanisms. For example, as illustrated in FIG. 1A, the resource request layer 106 may intercept the request 104 from the application's 102 ordinary request mechanisms. The resource request layer 106 can then reroute requests and receive responses either from the primary resource store 108 or from a backup resource store 110. The resource request layer 106 can provide responses 114 back to the application 102.

Further, the methods may be practiced by a computer system including one or more processors and computer readable media such as computer memory. In particular, the computer memory may store computer executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer readable storage media and transmission computer readable media.

Physical computer readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer readable media to physical computer readable storage media (or vice versa). For example, computer-executable instructions or data structures received over a network or data link can be buffered in RAM within a network interface module (e.g., a “NIC”), and then eventually transferred to computer system RAM and/or to less volatile computer readable physical storage media at a computer system. Thus, computer readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment, a method of providing access to resources to an application, the method comprising:
receiving a request from an application on a local machine for one or more resources;
determining that the one or more resources are not available on the local machine;
identifying one or more alternative locations where the one or more resources are available; and
transparently to the application, providing the one or more resources from one or more of the one or more alternative locations.

2. The method of claim 1, wherein providing the one or more resources from the one or more alternative locations comprises migrating the one or more resources to the local machine.

3. The method of claim 1, wherein providing the one or more resources from the one or more alternative locations comprises repairing an installation of the application at the local machine using the one or more resources from the alternative location.

4. The method of claim 1, wherein providing the one or more resources from the one or more alternative locations comprises building a redistributable package that contains resources to redistribute the application to another destination.

5. The method of claim 1, further comprising querying one or more of the one or more alternative locations on behalf of the application.

6. The method of claim 1, wherein identifying one or more alternative locations where the one or more resources are available comprises identifying an optimal alternative location and obtaining the one or more resources from the optimal alternative location.

7. The method of claim 1, wherein providing the one or more resources from the one or more alternative locations comprises composing resources from multiple alternative locations to satisfy a single request from the application.

8. The method of claim 1, wherein receiving a request from an application on a local machine for one or more resources comprises intercepting a request from the application's ordinary request mechanisms.

9. One or more computer readable media comprising computer executable instructions that when executed by one or more processors causes one or more processors to perform the following:
receiving a request from an application for one or more resources;
determining that the one or more resources are not available at a primary storage;
identifying one or more alternative locations where the one or more resources are available; and
transparently to the application, providing the one or more resources from one or more of the one or more alternative locations.

10. The computer readable media of claim 8, wherein, providing the one or more resources from the one or more alternative locations comprises migrating the one or more resources to a local machine having the application installed thereon.

11. The computer readable media of claim 8, wherein, providing the one or more resources from the one or more alternative locations comprises repairing an installation of the application at a local machine having the application installed thereon using the one or more resources from the alternative location.

12. The computer readable media of claim 8, further comprising querying one or more of the one or more alternative locations on behalf of the application.

13. The computer readable media of claim 8, wherein identifying one or more alternative locations where the one or more resources are available comprises identifying an optimal alternative location and obtaining the one or more resources from the optimal alternative location.

14. The computer readable media of claim 8, wherein providing the one or more resources from the one or more alternative locations comprises composing resources from multiple alternative locations to satisfy a single request from the application.

15. The computer readable media of claim 8, wherein receiving a request from an application for one or more resources comprises intercepting a request from the application's ordinary request mechanisms.

16. A computing system for providing access to resources to an application, the computing system comprising:
one or more processors;
one or more computer readable media coupled to the one or more processors, wherein the one or more computer readable media comprise computer executable instructions that when executed by one or more of the one or more processors, cause one or more of the one or more processors to perform the following:
receiving a request from an application on a local machine for one or more resources;
determining that the one or more resources are not available on the local machine;
identifying one or more alternative locations where the one or more resources are available;
retrieving the one or more resources from the one or more alternative locations;
storing the one or more resources on the local machine; and
transparently to the application, providing the one or more resources from one or more of the one or more alternative locations.

17. The computing system of claim 15, wherein, providing the one or more resources from the one or more alternative locations comprises migrating the one or more resources to the local machine.

18. The computing system of claim 15, providing the one or more resources from the one or more alternative locations comprises repairing an installation of the application at the local machine using the one or more resources from the alternative location.

19. The computing system of claim 15, further comprising querying one or more of the one or more alternative locations on behalf of the application.

20. The computing system of claim 15, wherein identifying one or more alternative locations where the one or more resources are available comprises identifying an optimal alternative location and obtaining the one or more resources from the optimal alternative location.
